(19) United States
(12) Patent Application Publication
(10) Pub. No.: US 2013/0044357 A1
(43) Pub. Date: Feb. 21, 2013

(54) ORIGINAL DOCUMENT SIZE DETECTION DEVICE

(71) Applicants: Masaya IGAWA, Shizuoka (JP); Satoshi KOMATSU, Tokyo (JP); Hiroyuki OKADA, Tokyo (JP); Koushi TAKANO, Tokyo (JP); Takao SAKURAI, Tokyo (JP)

(72) Inventors: Masaya IGAWA, Shizuoka (JP); Satoshi KOMATSU, Tokyo (JP); Hiroyuki OKADA, Tokyo (JP); Koushi TAKANO, Tokyo (JP); Takao SAKURAI, Tokyo (JP)

(73) Assignees: NEC ENGINEERING, LTD., Tokyo (JP); NEC ACCESS TECHNICA, LTD., Shizuoka (JP)

(21) Appl. No.: 13/586,389

(22) Filed: Aug. 15, 2012

(30) Foreign Application Priority Data
Aug. 16, 2011 (JP) 2011-178065

(51) Int. Cl. H04N 1/04

(52) U.S. Cl. 358/474

(57) ABSTRACT

An original document size detection device characterized by comprising a document reading table, a light source which irradiates an original document placed on the document reading table, a cover body which covers the original document, a light detection unit which detects a reflected light that a light from the light source is reflected by the original document, an angle detection unit which detects an opening angle of the cover body and has a first photo sensor, a second photo sensor, a third photo sensor, and a shield plate, and a determination unit which determines the size of the original document in a sub-scanning direction when the opening angle of the cover body is equal to an angle al and the size of the original document in a main scanning direction when the opening angle of the cover body is equal to an angle α2 (α1>α2) based on an output signal of the light detection unit and an output signal of the angle detection unit.

This application is based upon and claims the benefit of priority from Japanese Patent Application No. 2011-178065, filed on Aug. 16, 2011, the disclosure of which is incorporated herein in its entirety by reference.

### TECHNICAL FIELD

The present invention relates to an original document size detection device.

### BACKGROUND ART

A device such as a copier, a facsimile machine, or the like has an image reading unit. The image reading unit includes an optical module. The optical module includes for example, a light source, a photoelectric conversion element (for example, a CCD), a plurality of mirrors, and a lens. The light source irradiates an original document placed on a document reading table. The light emitted by the light source is reflected by the original document and the reflected light is reflected by the mirror to lead it to the CCD. The lens is disposed between the mirror and the CCD, concentrates the light reflected by the mirror, and forms an image on the CCD. A wire is connected to the both ends of the optical module. A drum around which the wire is wound is driven by rotation of a motor. Whereby, the wire is spooled, the optical module is pulled in a sub-scanning direction (the sub-scanning direction is perpendicular to a main scanning direction), and the optical module is moved parallel to the original document in the sub-scanning direction. By this, the image is read. When a cover body of an ADF unit (automatic document feeder) is closed after the original document is placed on the document reading table, the image reading unit detects (determines) the size of the original document in both the main scanning direction and the sub-scanning direction (the width and the length of the original document are detected). Namely, the size such as A4 size, A3 size, B4 size, or the like of the original document placed on the document reading table is determined.

The size of the original document in the main scanning direction (the length of the original document) is detected/determined based on a change in an output waveform of the CCD that appears at a certain position when the optical module reads the original document in the main scanning direction. The output waveform of the CCD greatly changes at a boundary between an area in which the original document exists and an area in which it does not exist when the original document is read in the main scanning direction. Namely, because the output waveform of the CCD greatly changes at the boundary, it can be known that the position at which the output waveform of the CCD greatly changes is the position of the edge of the original document.

A size sensor disposed to a rail in the sub-scanning direction on which the optical module moves is used for the detection of the size of the original document in the sub-scanning direction. A photo sensor composed of a pair of units (a light emission unit and a light reception unit) is used for the size sensor. The original document is detected by the size sensor as follows. The light emission unit of the size sensor emits the light, the original document is irradiated with the light, the light is reflected by the original document, and when the light reception unit of the size sensor receives the reflected light, it is determined that the original document exists. When the reflected light from the original document is not received by the light reception unit of the size sensor, it is determined that the original document does not exist. The size sensor is composed of a plurality of photo sensors (for example, two photo sensors). The size of the original document in the sub-scanning direction is determined based on the combination of the signals from two photo sensors.

The basic technology method for detecting (determining) the size of the original document placed on the document reading table has been explained above. When the size of the original document in the main scanning direction and the size of the original document in the sub-scanning direction are detected, a specific opening angle (closing angle) of the cover body of the ADF unit is used as a trigger. For this reason, a cover body angle detection mechanism is provided in a device in order to achieve the detection of the size of the original document when the closing angle of the cover body reaches a set angle (the specific closing angle).

The device disclosed in Japanese Patent Application Laid-Open No. 2004-258386 (hereinafter, patent document 1) includes two or three optical sensors that are disposed on one line in a vertical direction and a sensor flag for blocking the light of the optical sensor (the sensor flag moves upward and downward according to a cover body opening angle). The opening angle of the cover body is determined by the height position of the optical sensor that detects the position (height) of the sensor flag.

The rotation angle detection device in which two sets of combinations of angle data that are adjacent does not overlap during one rotation of a rotation plate and a CPU calculates a rotation angle of the rotation plate by comparing a combination of a binary code obtained by the optical sensor and a past binary code obtained at the previous time with the combination of the angle data is disclosed in Japanese Patent Application Laid-Open No. 2006-177912 (hereinafter, patent document 2). As a result, the rotation angle of the rotation plate can be obtained.

In Japanese Patent Application Laid-Open No. 2007-139607 (hereinafter, patent document 3), a sensor mounting structure characterized in that a pair of transmission/reception vibrators is held in a housing hole or by a housing holder in a point-contact manner (or in a very light contact manner similar to the point-contact manner) is disclosed. By this structure, the vibration of the transmission/reception vibrator is less likely to be transmitted to the housing hole or the housing holder and whereby, a surface acoustic wave generated by one of the transmission/reception vibrators is less likely to be transmitted to the other transmission/reception vibrator (it is less likely to act as disturbance).

However, in the device disclosed in patent document 1, especially, when the cover body is closed at high speed, a problem in which the size of the original document in a main scanning direction cannot be correctly determined occurs. In a case in which the size detection is performed twice for example, when the cover body opening angle reaches 18 degrees and 12 degrees, a high-speed response (a high-speed processing) cannot be achieved by using two optical sensors. The problem generated when the cover body is closed at high speed is caused by a time after the sensor is physically switched until a control side recognizes the switching. When the high-speed response is required, an interrupt processing method by which the switching of the output signal of the sensor is used as a trigger and the process starts when the trigger occurs is used. In order to perform this interrupt processing, it is necessary to set an interrupt detection port to the CPU at an initial stage of designing a substrate. However, because the total number of ports which can be set in the CPU is limited and the number of ports required by the other function increases with the increase of the number of functions provided for the device, the interrupt detection port cannot be additionally provided. Therefore, it is desirable that the number of the interrupt ports used for the cover body angle detection is one. When two optical sensors are used like the device disclosed in patent document 1, the device cannot be realized by using one port. In patent document 1, a case in which three optical sensors are used is described. However, in this case, the device using one port cannot be realized like the case in which the device uses two optical sensors. For this reason, when the necessity of increasing or decreasing the number of the original document size detection angles occurs, this cannot be achieved. Therefore, there is a possibility that the size of the original document is erroneously detected when the cover body is closed at high speed. In patent document 2 or 3, means to solve the above-mentioned problem are not disclosed.

### SUMMARY

An object of the present invention is to solve the above-mentioned problem. In particular, the object of the present invention is to provide a low price original document size detection device which can correctly determine a size of an original document placed on a document reading table even when the cover body is closed at high speed.

### BRIEF DESCRIPTION OF THE DRAWINGS

Exemplary features and advantages of the present invention will become apparent from the following detailed description when taken with the accompanying drawings in which:

FIG. 1 is a block diagram of an original document size detection device,

FIG. 2 is a figure showing a relation between a photo sensor and a cover body opening angle,

FIG. 3 is an explanatory drawing showing a method for mounting an actuator unit that acts as a cover body angle detection mechanism,

FIG. 4 is a side view showing a method for mounting a transmissive photo sensor,

FIG. 5 is a front view showing a method for mounting a transmissive photo sensor,

FIG. 6 is an explanatory drawing showing a relation between a transmissive photo sensor and a shield plate when a cover body opening angle α>18 degrees,

FIG. 7 is an explanatory drawing showing a relation between a transmissive photo sensor and a shield plate when a cover body opening angle α=18 degrees,

FIG. 8 is an explanatory drawing showing a relation between a transmissive photo sensor and a shield plate when a cover body opening angle α=12 degrees,

FIG. 9 is an explanatory drawing showing a relation between a transmissive photo sensor and a shield plate when a cover body opening angle α=0 degree,

FIG. 10 is a schematic perspective view of an original document size detection device in a cover body open state,

FIG. 11 is a schematic perspective view showing an internal mechanism of an original document size detection device,

FIG. 12 is a figure showing an internal mechanism of an original document size detection device,

FIG. 13 is a figure showing a method for mounting a reflection type size sensor,

FIG. 14 is an explanatory drawing showing an external light entering a surface of a document reading table of an original document size detection device when a cover body is closed,

FIG. 15 shows a CCD output when an external light enters a surface of a document reading table of an original document size detection device,

FIG. 16 shows a CCD output when an external light enters a surface of a document reading table of an original document size detection device, and

FIG. 17 shows a CCD output when an external light enters a surface of a document reading table of an original document size detection device.

### EXEMPLARY EMBODIMENT

An original document size detection device according to the present invention is installed in an image reading device such as for example, a facsimile machine, a copier, a complex machine, or the like. However, it is not limited to these devices.

The original document size detection device according to the present invention has a function to automatically detect the sizes of the original document in the main scanning direction and the sub-scanning direction by an image reading device (for example, the image reading device has the cover body which can be opened and closed on the document reading table and reads an image of the original document placed on the document reading table by moving the CCD arranged in the main scanning direction of the original document in the sub-scanning direction).

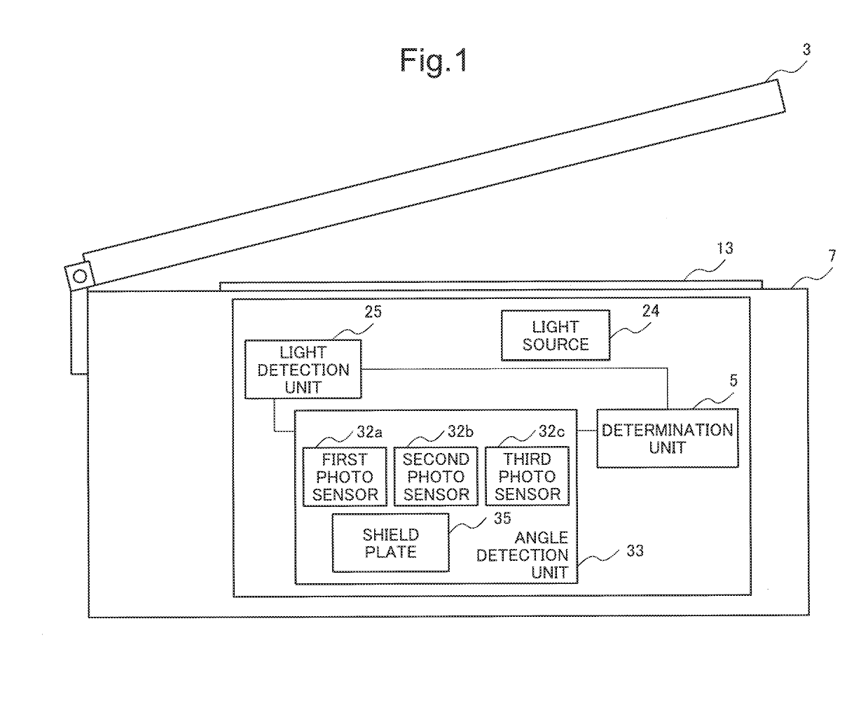

As shown in FIG. 1, the original document size detection device comprises a document reading table 7, a light source 24 which irradiates an original document 13 placed on the document reading table 7, a cover body (a document lid) 3 which covers the original document placed on the document reading table 7, a light detection unit (for example, a CCD) 25 which detects a light that is emitted by the light source 24 and reflected by the original document 13 placed on the document reading table 7, an angle detection unit 33 which detects an opening angle of the cover body and is composed of three photo sensors 32 (a first photo sensor 32a, a second photo sensor 32b, and a third photo sensor 32c) and a shield plate, and a determination unit 5 which determines the size of the original document 13 in a sub-scanning direction when the opening angle (the closing angle) of the cover body 3 is equal to the angle α1 and the size of the original document 13 in a main scanning direction when the opening angle (the closing angle) of the cover body 3 is equal to the angle α2 (α1>α2) based on an output signal of the light detection unit 25 and the angle detection unit 33.

The original document size detection device of the present invention will be described in detail below. At least when the above-mentioned configuration is used, a low price document reading device which can correctly determine the size of the original document placed on the document reading table even when the cover body is closed at high speed can be provided.

The determination units 5 is a computer and it is for example, a CPU. Therefore, only one interrupt port is enough for the detection of the cover body angle.

The angle (opening angle: closing angle) detection unit 33 (hereinafter called an actuator unit 33) for the cover body 3 is composed of three transmissive photo sensors 32 (32a, 32b, and 32c) and two shield plates 35 (a first shield plate 35a and a second shield plate 35bc).

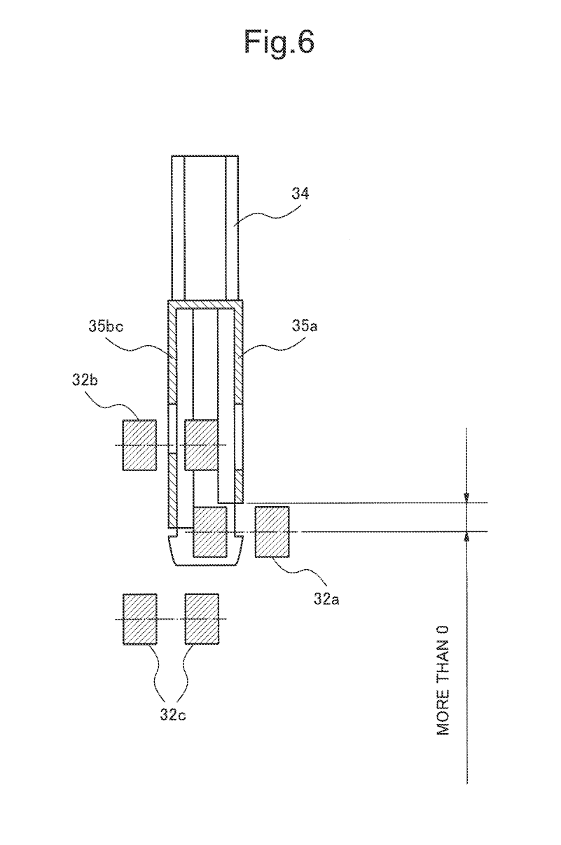

The actuator unit 33 further includes the base 37, a rod 34, and a spring 36. The rod 34 is upwardly urged by the spring 36. When the cover body 3 is in a closed state or in a closing state, it is in contact with the end of the rod 34. Accordingly, the position of the rod 34 in a vertical direction relates to the closing angle (the opening angle) of the cover body 3. Namely, the rod 34 moves up and down in conjunction with the opening/closing operation of the cover body 3. Here, in a state in which the cover body 3 is greatly opened by for example, 90 degrees (an angle smaller than 90 degrees may be applied), even when a pressing pressure from the cover body 3 side does not act on the upper end of the rod 34 and an upward urging force is applied to the rod 34 by the spring 36, the rod 34 does not come off. In order to perform this operation, for example, a structure in which a part of the actuator unit 33 is latched at a proper position of the base 37 or the chassis 38 and whereby, the rod 34 cannot move upward any more is used. For example, a structure in which the shield plates 35 (35a and 35bc) cannot move upward from a position shown in FIG. 6 is used.

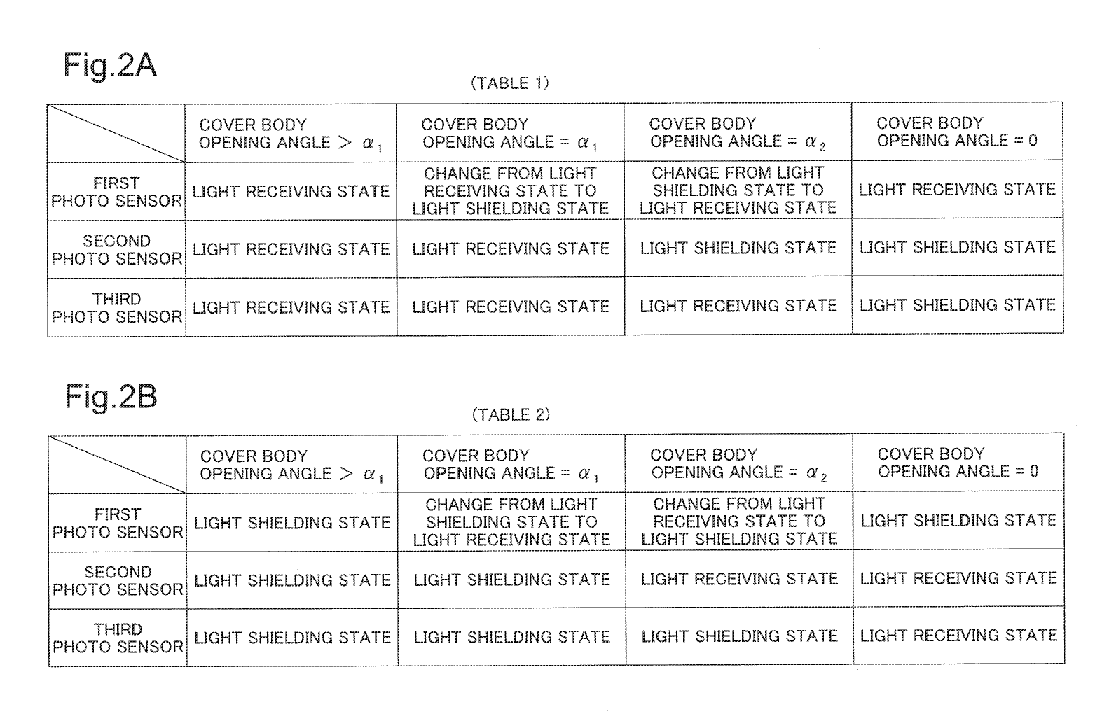

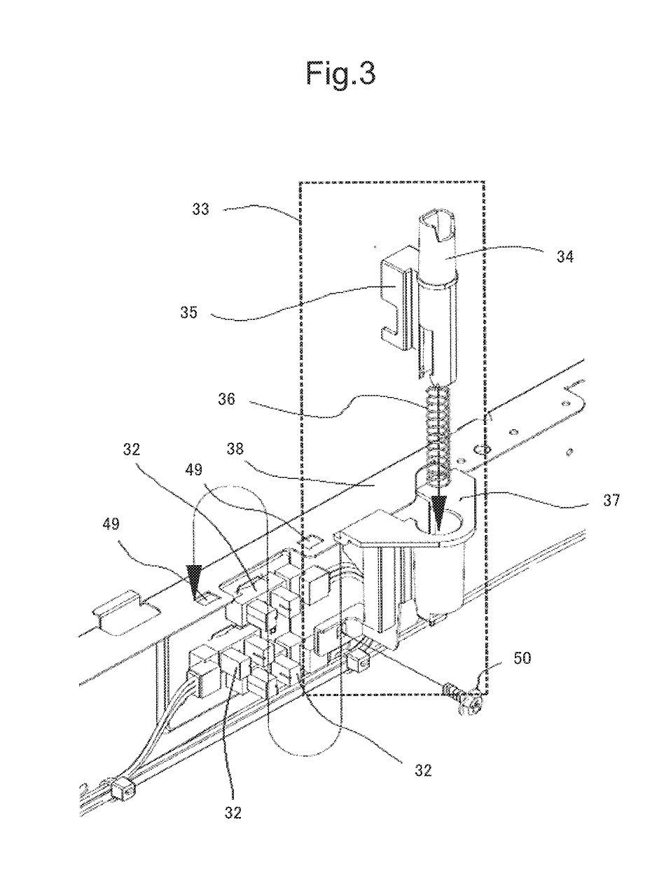

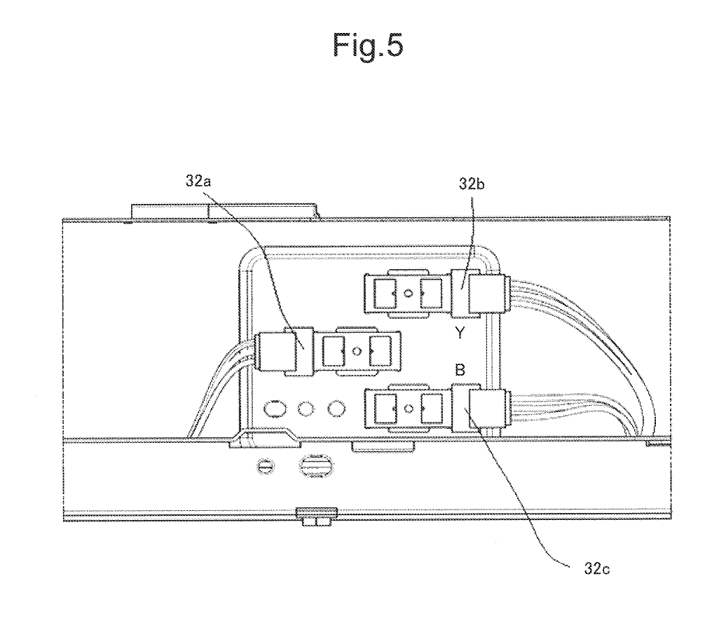

As shown in FIGS. 3 to 9, the transmissive photo sensors 32 (32a, 32b, and 32c) are disposed at a rear side of the device. Because the transmissive photo sensors 32 are disposed at the rear side of the device, it is not necessary to extend a cable to the front side of the device, a short cable can be used, and whereby, the cost of the device can be reduced. Three transmissive photo sensors 32 (32a, 32b, and 32c) are arranged so that the photo sensors are operated according to the operation table of FIG. 2A or FIG. 2B.

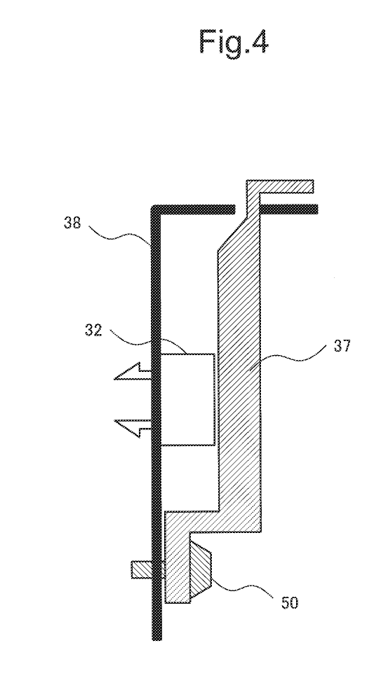

The arrangement or the like of the photo sensors 32 will be described in detail below. As shown in FIG. 4, a latching claw of the transmissive photo sensor 32 is inserted in a hole provided to a chassis 38. By this, the transmissive photo sensor 32 is latched (fixed) to the chassis 38. If the transmissive photo sensor 32 is used in this condition, there is a possibility that the latching claw is unlatched by an external force because the transmissive photo sensor 32 is only hooked in the hole by the latching claw. To prevent this problem, a base 37 of an actuator unit 33 including two shield plates 35 is pushed so as to make contact with the transmissive photo sensor 32. Whereby, the actuator unit 33 is inserted into a hole 49 of the chassis 38. Namely, the transmissive photo sensor 32 is disposed so that it is sandwiched between the base 37 and the chassis 38. After this, the actuator unit 33 is fixed to the chassis 38 with a screw 50. By using this structure, the transmissive photo sensor 32 is firmly fixed to the chassis 38 without looseness.

Three transmissive photo sensors 32 (the first photo sensor 32a, the second photo sensor 32b, and the third photo sensor 32c) and two shield plates 35 (35a and 35bc) are configured as follows (for example). The second photo sensor 32b and the third photo sensor 32c are disposed at a side of the first photo sensor 32a. The second photo sensor 32b and the third photo sensor 32c are disposed on the same line in the vertical direction. The shield plate 35a with the notch is disposed at a location corresponding to the first photo sensor 32a. The shield plate 35a that moves upward and downward blocks (intercepts) or transmits (receives) the light of the first photo sensor 32a according to the position (the height) of the shield plate 35a. The shield plate 35bc with the notch is disposed at a location corresponding to the second photo sensor 32b and the third photo sensor 32c. The shield plate 35bc that moves upward and downward blocks (intercepts) or transmits (receives) the light of the second photo sensor 32b and the light of the third photo sensor 32c according to the position (the height) of the shield plate 35bc. In particular, as shown in FIG. 6, the shield plate 35 and the transmissive photo sensor 32 are disposed (arranged) so that the shield plates 35 (35a and 35bc) does not block (intercept) the light of each of the transmissive photo sensors 32 (the first photo sensor 32a, the second photo sensor 32b, and the third photo sensor 32c) when the cover body 3 is sufficiently lifted.

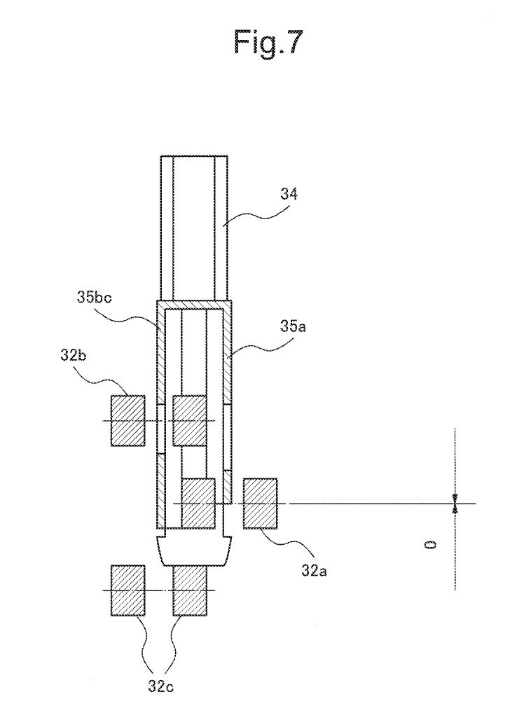

When the cover body 3 is closed, the shield plate 35 and the transmissive photo sensors 32 are disposed (arranged) so that the positional relationship between them shown in FIG. 7 is obtained when the cover body opening angle reaches the angle α1 (for example, 18 degrees). Namely, the shield plate 35a is disposed (arranged) so as to start to block (intercept) the light of the first photo sensor 32a. Further, the shield plate 35bc is disposed (arranged) so as not to block (intercept) the light of the second photo sensor 32b and the light of the third photo sensor 32c.

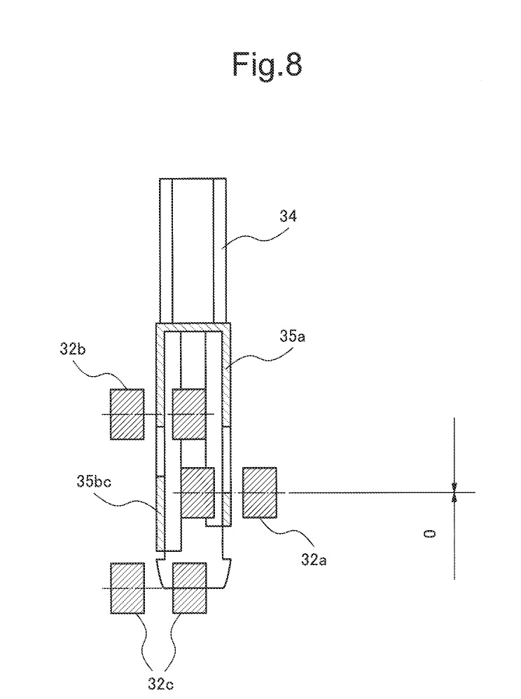

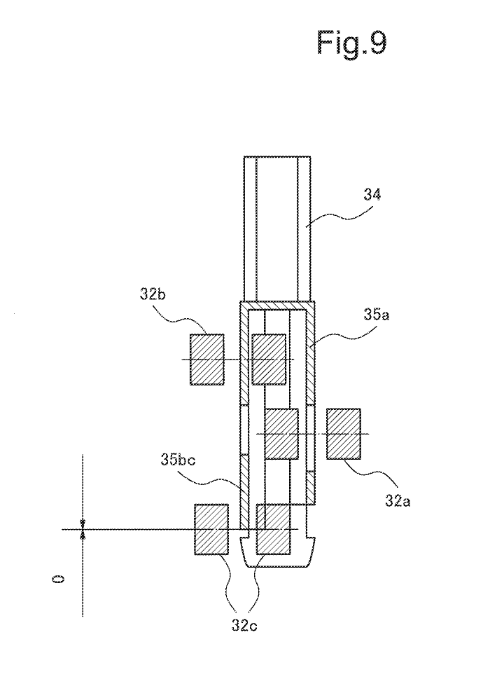

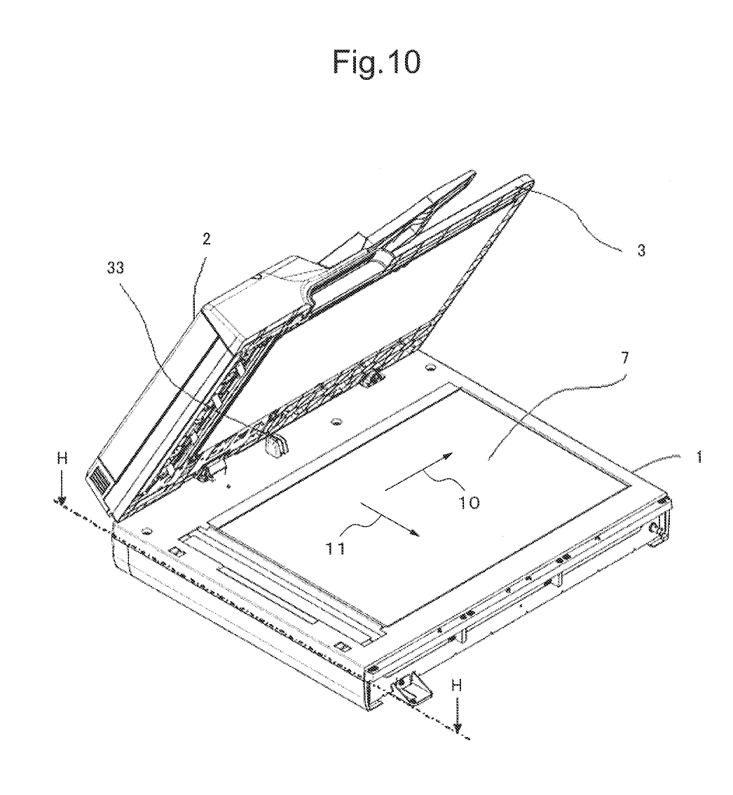

When the cover body 3 is further closed, the shield plate 35 and the transmissive photo sensor 32 are disposed (arranged) so that the positional relationship between them shown in FIG. 8 is obtained when the cover body opening angle reaches the angle α2 (for example, 12 degrees). Namely, because the light of the first photo sensor 32a starts to pass through the notch of the shield plate 35a, the state of the first photo sensor 32a changes from a light shielding (blocking) state to the light receiving state and the state of the second photo sensor 32b changes from the light receiving state to the light shielding (blocking) state by the shield plate 35bc. However, the third photo sensor 32c still remains in the light receiving state. When the cover body 3 is completely closed (the cover body opening angle is 0 degree), the shield plate 35 and the transmissive photo sensor 32 are disposed (arranged) so that the positional relationship between them shown in FIG. 9 is obtained. Namely, because the light of the first photo sensor 32a passes through the notch of the shield plate 35a, the first photo sensor 32a still remains in the light receiving state and the second photo sensor 32b still remains in the light blocking (intercepting) state by the shield plate 35bc. However, the state of the third photo sensor 32c that has been in the light receiving state is changed to the light blocking (intercepting) state by the shield plate 35bc.

As a result, the first transmissive photo sensor 32a, the second transmissive photo sensor 32b, and the third transmissive photo sensor 32c are set to a state (Low (light receiving state) or High (light shielding state)) shown in the operation table of FIG. 2A (or FIG. 2B) by two shield plates 35 (35a and 35bc) that move upward and downward together with the rod 34 that moves upward and downward in conjunction with the closing angle (the opening angle) of the cover body 3. In the above-mentioned specific example that is composed of three photo sensors 32a, 32b, and 32c and two shield plates 35a and 35bc, the angle α1 of 18 degrees and the angle α2 of 12 degrees were used. The original document 13 is placed on the document reading table 7 and the cover body 3 starts to be closed. At the time of starting to close the cover body 3, the positional relationship between three photo sensors 32a, 32b, and 32c and two shield plates 35a and 35bc is shown in FIG. 6. At this time, the shield plates 35a and 35bc does not reach the position of each of the photo sensors 32a, 32b and 32c. Accordingly, the light emitted by the light emission unit is received by the light reception unit with respect to all the photo sensors 32a, 32b and 32c. When the photo sensors 32a, 32b and 32c are in this state, the output of each photo sensor is Low. The output of each of the photo sensors 32a, 32b and 32c remains in a Low state (the light reception unit receives the light emitted by the light emission unit with respect to each of the photo sensors 32a, 32b, and 32c) until the opening angle (the closing angle) of the cover body 3 reaches 18 degrees.

When the opening angle (the closing angle) of the cover body 3 reaches 18 degrees, the lower end of the shield plate 35a blocks the light emitted by the light emission unit of the photo sensor 32a (refer to FIG. 7). By this, the output of the first photo sensor 32a is changed (switched) from “Low” to “High”. However, in the second photo sensor 32b and the third photo sensor 32c, because the shield plate 35bc does not block the light emitted by the light emission unit of each of the photo sensors 32b and 32c, the light emitted by the light emission unit of each of the photo sensors 32b and 32c is received by the light reception unit of each of the photo sensors 32b and 32c. Accordingly, the output of the photo sensor 32b and the output of the photo sensor 32c are still “Low”. When the output of the second photo sensor 32b and the output of the third photo sensor 32c are “Low” and the output of the first photo sensor 32a changes from “Low” to “High”, the opening angle (the closing angle) of the cover body 3 is equal to the angle α1 (for example, 18 degrees).

The cover body 3 is further closed. The output state of each of three photo sensors 32a, 32b, and 32c is the same as the output state when the opening angle (the closing angle) of the cover body 3 is equal to the angle α1 (for example, 18 degrees) until the opening angle (the closing angle) of the cover body 3 reaches the angle α2 (for example, 12 degrees).

When the opening angle (the closing angle) of the cover body 3 reaches the angle α2 (for example, 12 degrees), the light-shielding by the shield plate 35a is released. Namely, in the first photo sensor 32a, the light emitted by the light emission unit is received by the light reception unit. Accordingly, the output of the first photo sensor 32a is changed (switched) from “High” to “Low”. When the opening angle (the closing angle) of the cover body 3 is equal to 12 degrees, the shield plate 35bc blocks the light emitted by the light emission unit of the photo sensor 32b. By this, the output of the second photo sensor 32b is changed (switched) from “Low” to “High”. However, in the third photo sensor 32c, because the shield plate 35bc does not block the light emitted by the light emission unit of the photo sensor 32c, the light is received by the light reception unit of the photo sensor 32c (refer to FIG. 8). Accordingly, the output of the photo sensor 32c is still “Low”. The cover body 3 is further closed. The output state of each of three photo sensors 32a, 32b, and 32c is the same as the output state when the opening angle (the closing angle) of the cover body 3 is equal to 12 degrees before the cover body 3 is completely closed. When the cover body 3 has been completely closed, the output state of each of the first and second photo sensors 32a and 32b is not changed but in the third photo sensor, the light emitted by the light emission unit of the third photo sensor is blocked by the shield plate 35bc (refer to FIG. 9). Namely, the output of the third photo sensor is changed (switched) from “Low” to “High”.

Thus, two shield plates 35 (35a and 35bc) block (intercept) and pass (transmit: receive) the sensor light of three transmissive photo sensors 32 (32a, 32b, and 32c). The opening angle (the closing angle) of the cover body is detected based on the combination of the outputs of three transmissive photo sensors 32 (32a, 32b, and 32c). By using this mechanism, the size of the original document can be detected by using the low price transmissive photo sensor without using an expensive proximity switch. Because the proximity switch provided at the front side of the image reading device and a magnet attached to the cover body are not required, a space can be reduced. By using the rod 34 with the shield plate 35 shown in FIG. 3, the trigger for angle detection is concentrated on only one photo sensor 32a and the number of the interrupt detection ports can be reduced by one. As a result, a signal is switched with respect to the cover body opening angle at which the original document size detection is performed and when the interrupt processing is performed, the cover body opening angle is determined based on the operation table of FIGS. 2A and 2B. Therefore, the number of the cover body opening angles that have to be detected can be increased or decreased and whereby, the size of the original document can be surely detected.

When the size of the original document in the main scanning direction 11 is detected, the light toward the original document can not be completely blocked by the cover body 3. There is a case in which the external light 28 such as the light of a fluorescent lamp, the light of the sun, or the like may enter the CCD (light detection unit) 25 in addition to the light that is emitted by the light source 24 and reflected by the original document 13. The CCD output waveform is affected by this external light 28. As a result, the erroneous detection of the size of the original document occurs. Therefore, the original document size detection device according to the present invention includes a masking unit (not shown) which masks the signal based on the incident external light 28 when the opening angle (closing angle) of the cover body 3 is the angle α2 which is included in the output signal of the CCD 25. The masking unit facilitates correct determination of an original document end corresponding portion 29a with respect to information (a CCD output waveform 29) obtained by performing a photoelectric conversion of the light reflected by the original document 13 that is read by the CCD 25. When the masking unit performs an electric process to the CCD output information, a desired area of the CCD output waveform 29 is masked. By using the masking unit, even when the external light 28 enters, a region in which the CCD output waveform varies by the external light 28 is excluded when the CPU determines the size of the original document. As a result, the size of the original document can be determined without being affected by the external light.

For example, the image reading device such as a facsimile machine, a copier, or the like usually uses a short focus lens having a short optical path length from a viewpoint of weight reduction, miniaturization, space saving, and cost reduction. Because the short focus lens has a wide field angle, the view angle of the optical module is wide. This means that the detection of the size of the original document is affected by the external light (for example, the light of a fluorescent lamp provided on a ceiling or the light of the sun) 28 which cannot be blocked by the cover body 3 when the cover body 3 is being closed. In other words, the external light 28 which cannot be blocked by the cover body 3 enters the surface of the document reading table 7. When the size of the original document in the main scanning direction 11 is detected in this state, the waveform (the convex waveform) caused by the external light 28 is generated in the CCD output waveform when the original document 13 does not exist in an area which the external light 28 enters. When the convex waveform is generated, it is erroneously determined that the position of the convex waveform end is the position of the edge of the original document 13. Namely, the position of the edge of the original document cannot be correctly detected.

Therefore, in the device using the short focus lens, in order to solve this problem, extension of the cover body in a direction toward a front side (a user side) of the device may be performed. Namely, when the cover body 3 is extended in a direction toward the front side (user side) of the device, the external light 28 does not enter the surface of the document reading table even when the cover body 3 is being closed. Therefore, the erroneous operation hardly occurs. However, when this method is used, the size of the device becomes large. The masking unit performs the electric masking process for masking the output waveform in an area that corresponds to the area on the surface of the document reading table which the external light 28 enters. By this, the size of the original document can be correctly detected even when the cover body 3 is not extended in the direction toward the front side of the device (user side), and in other words, even when the external light 28 enters the surface of the document reading table 7. By this process, the convex waveform is electrically eliminated and the detection of the size of the original document is not affected by the external light 28.

The electric masking process is applied to the output signal in an area that corresponds to an area between a position between the edge of the original document having the maximum width in the main scanning direction 11 and the edge of the original document having a width that is one size smaller than the maximum width and a maximum reading position in the main scanning direction. Namely, the opening angle (the closing angle) of the cover body 3 when the size of the original document in the main scanning direction is detected is set so that the output signal in an area that corresponds to the area on the surface of the document reading table which the external light enters is masked by the electric masking process. When the electric masking process is applied to the output signal in the above-mentioned area and the output signal does not remain in the High state in the masking area, it is determined that the size of the original document in the main scanning direction is a size corresponding to a position at which the output signal changes from the High state to the Low state. When the output signal remains in the High state in the masking area, the edge of the original document cannot be discriminated. Accordingly, in this case, it is determined that the size of the original document is maximum. When the original document size detection device is configured as described above, it is not necessary to extend the cover body 3 in the direction toward the front side of the device. Therefore, the size of the device can be reduced. All sizes of the original documents can be detected without being affected by the external light.

In the original document size detection device according to the present invention, it is desirable that a hinge is used to open and close the cover body 3 and a hinge shaft is disposed at one edge side of the document reading table along the sub-scanning direction. The shield plate 35 is disposed at the end of a hinge rotation shaft core side of the cover body 3.

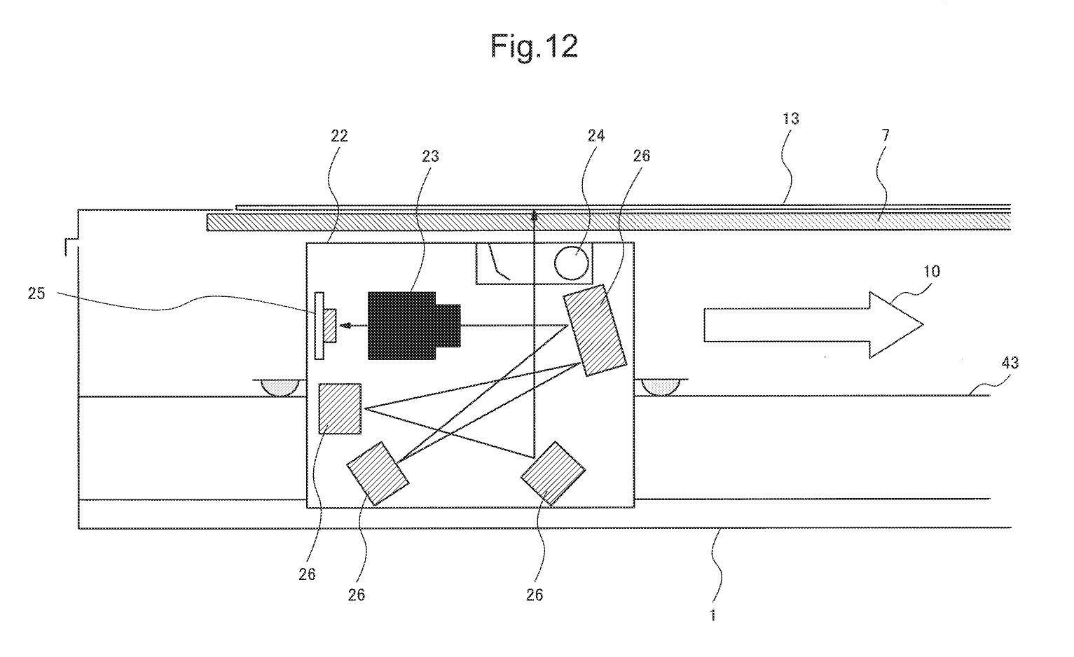

The original document size detection device according to the present invention includes a movable optical module 22. As shown in FIG. 12, the optical module 22 comprises the light source 24 which irradiates the original document 13 placed on the document reading table 7 of an image reading device 1, a plurality of mirrors 26 which reflects the light that is emitted by the light source 24 and reflected by the original document 13 to lead it to a photoelectric conversion element (CCD) 25, and a lens 23. The lens 23 is disposed between the mirror 26 and the CCD 25, concentrates the light reflected by the mirror 26, and forms an image on the CCD 25.

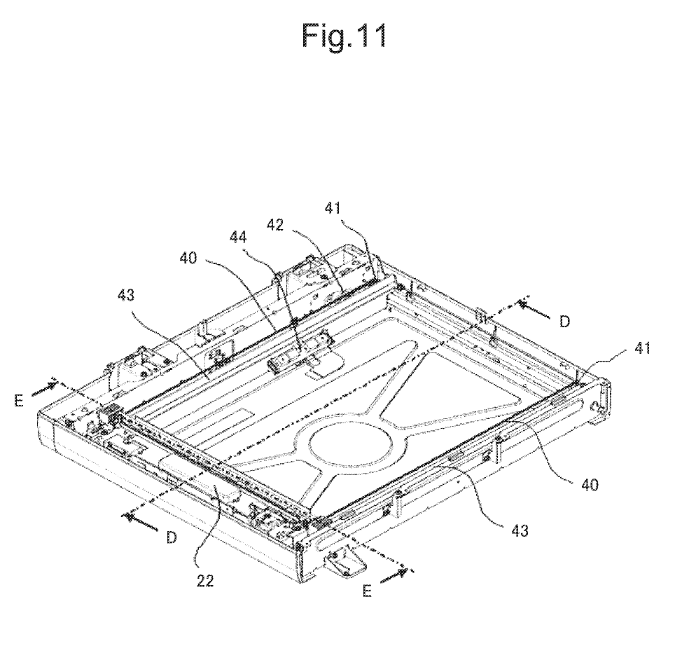

In order to move the optical module 22 in a sub-scanning direction 10, as shown in FIG. 11, the optical module 22 is mounted on an upper portion of two rails 43 that are disposed in the sub-scanning direction 10. A wire 40 is connected to the both ends of the optical module 22. In order to move the optical module 22 in the sub-scanning direction 10, a drum 41 around which the wire 40 is wound and a drive unit 42 which rotates the drum 41 are provided.

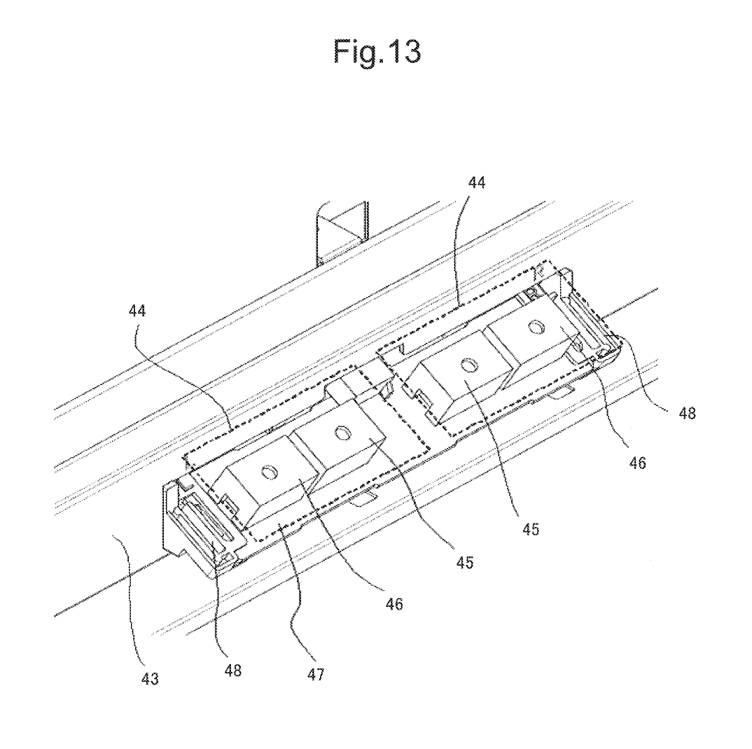

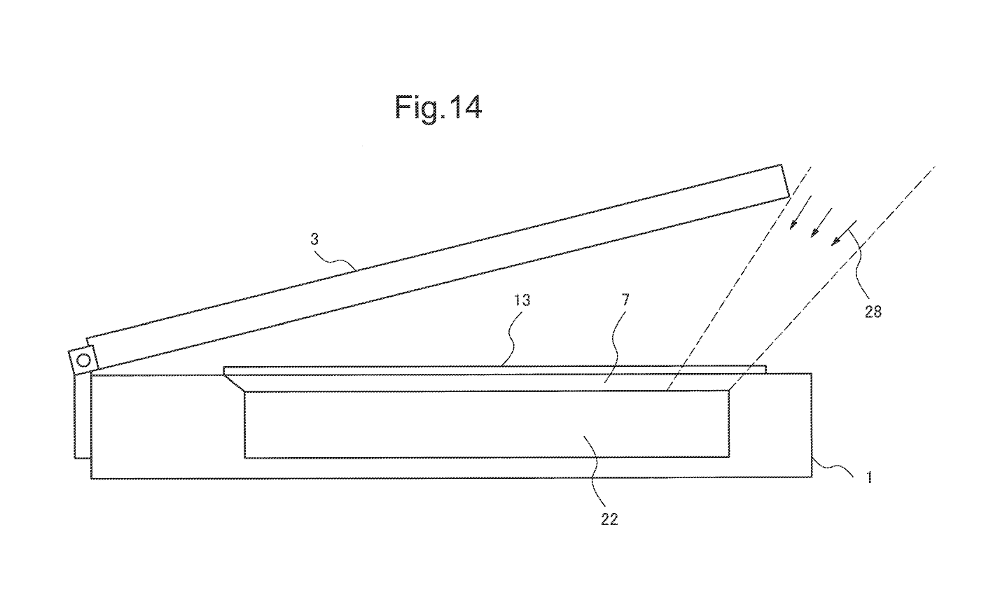

Two reflection type size sensors 44 are used for the detection of the size of the original document in the sub-scanning direction 10. As shown in FIG. 13, the reflection type size sensor 44 is composed of a pair of units (a light emission unit 45 and a light reception unit 46). The reflection type size sensor 44 is mounted on a rectangular substrate 47 whose long side is along the sub-scanning 10 direction. The reflection type size sensor 44 is held by two holders 48 fixed to the rail 43 on which the optical module 22 is mounted. Further, the reflection type size sensor 44 is obliquely fixed.

The CCD waveform based on the light that is emitted by the light source 24 and reflected by the original document 13 is used for the detection of the size of the original document in a main scanning direction 11 perpendicular to the sub-scanning direction 10. The opening angle (the closing angle) of the cover body 3 is used as an activation trigger for turning on the light source 24 for the detection of the size of the original document.

In the original document size detection device according to the present invention, the opening angle (the closing angle) of the cover body 3 is set so that the output signal in the area that corresponds to the area on the surface of the document reading table which the external light 28 enters can be masked.

In a device disclosed in Japanese Patent Application Laid-Open No. 2004-126132 (hereinafter, patent document 4), for the purpose of accuracy improvement of the original document size detection in the main scanning direction in which the countermeasure against the external light is taken for the original document size detection, when the cover body is closed, the size in the main scanning direction is detected when the angle of the cover body reaches a predetermined angle. The light source of the optical module is turned off just before detecting the size of the original document in the main scanning direction and the CCD output is read, an incident position of the external light is detected, and this is removed. By this, the influence of the external light is removed.

However, in the device disclosed in patent document 4, the CCD output is read twice, one is performed in a state in which the light source is turned off and the other is performed in a state in which the light source is turned on, in a short time until the lifted cover body is closed. For this reason, when the cover body is quickly closed by the operator, the original document detection cannot follow the lid closing speed and whereby, a false detection occurs. Usually, it takes several milliseconds to several tens of milliseconds until the CCD or the light source for the optical module stably operates after the power is turned on. Moreover, because the number of times of reading the CCD output increases, a software process becomes complicated.

In contrast, in the original document size detection device according to the present invention, the angle of the cover body is set so that the output signal in an area that corresponds to the area on the surface of the document reading table which the external light enters is masked by the electric masking process. Accordingly, it is not necessary to confirm the CCD output in advance in order to detect the incident position of the external light 28. In a process for confirming the CCD output waveform for original document size detection in the main scanning direction, the masking process is performed by deleting only the output waveform data in an area that corresponds to the external light incident area. Therefore, a load on software control for deleting the data in the area that corresponds to the external light incident area does not become especially large. Of course, because the data in the area that corresponds to the external light incident area is excluded by the masking, the influence of the external light can be removed. Accordingly, the influence of the external light is removed by performing a few process and the original document size detection determination can be performed with high accuracy. A load on software control does not become especially large because the electric masking process is used.

In the original document size detection device according to the present invention, the cover body opening angle at which the light source 24 is turned on and the cover body opening angle at which the reading for size detection is performed can be individually set.

In Japanese Patent Application Laid-Open No. 2006-261848 (hereinafter, patent document 5), as a method for detecting the size of the original document, a method in which when it is detected that the angle of the cover body reaches a specified angle, the light source is turned on by using this as a trigger, the detection operation is delayed for a predetermined time by a software-controlled timer until an amount of light emitted by the light source is equal to a specified amount of light, and when the predetermined time has elapsed, the reading is performed is proposed. However, even when this method is used, when the cover body is quickly closed by the operator, there is a case in which the reading for size detection starts after the cover body has been completely closed because of mismatch between the predetermined time of the timer and the lid closing speed. For this reason, there is a possibility that the false detection occurs. Further, the angle of the cover body at which the reading starts is not specified. Therefore, the angle of the cover body at which the reading starts is different for each operator because the cover body closing speed is different for each operator by individual variability. As a result, the result of the size detection varies. In the device disclosed in patent document 5, only one angle can be set with respect to the angle of the cover body that is used as the trigger of the operation.

In contrast, in the original document size detection device according to the present invention, a plurality of opening angles of the cover body that are used as the trigger of the operation (for turning on the light source and reading the original document) can be set. Namely, the cover body opening angle at which the light source is turned on and the cover body opening angle at which the reading for size detection is performed can be individually set. Therefore, the timing at which the light source 24 is turned on and the timing at which the reading is performed can be controlled separately. Because the operations are started at different timings, in other words, the operations are started at different cover body opening angles, the reading can be performed at the predetermined timing without relation to operator's lid closing speed. As a result, the accuracy of the original document size detection is improved.

In the original document size detection device according to the present invention, an angle range between 5 and 25 degrees is desirable for the angle α1 and the angle range between 12 and 22 degrees is further desirable for the angle α1. The angle range between 4 and 24 degrees is desirable for the angle α2 and the angle range between 8 and 18 degrees is further desirable for the angle α2. Here, α1>α2. The angle range between 1 and 10 degrees is desirable for the angle of (α1−α2) and the angle range between 4 and 8 degrees is further desirable for the angle of (α1−α2). The reason that the above-mentioned range is desirable is described below. When the angle α1 is too large, for example, the influence of the external light becomes excessive and there is a high possibility that the size of the original document is erroneously detected. When the angle α2 is too small, a transition time from the original document size detection operation to the next operation is too short and whereby, there is a high possibility that the size of the original document is erroneously detected. As a result of various experiments, when the angle is within the above-mentioned range, there was a small possibility that the size of the original document is erroneously detected.

Next, the operation of the original document size detection device according to the present invention will be described. The detection of the size of the original document is performed by using the opening angle (the closing angle) α of the cover body 3 as a trigger. When the lifted cover body 3 is completely closed (α=0 degree), the following operations (1) to (5) are performed in order: (1) the cover body is lifted, (2) the light source is turned on (α=18 degrees), (3) the size of the original document in the sub-scanning direction is detected (α=18 degrees), (4) the size of the original document in the main scanning direction is detected (α=12 degrees), and (5) the cover body is completely closed (α=0 degree). The angle α is detected by the mechanism for detecting the angle of the cover body 3 that is composed of three transmissive photo sensors 32a, 32b, and 32c and the actuator unit 33 (especially, two shield plates 35a and 35bc) and the above-mentioned operations (1), (2), (3), (4), and (5) are performed in order.

The above-mentioned operation (1) will be described in more detail. When the cover body 3 is sufficiently lifted, the rod 34 of the actuator unit 33 is not pressed by the cover body 3. At this time, because three transmissive photo sensors 32a, 32b, and 32c are in the “light receiving state”, the cover body 3 is in a state shown as “cover body opening angle>α1 (for example, 18 degrees)” in FIG. 2A. Therefore, the CPU determines that the cover body 3 is lifted.

After this, when the cover body 3 is closed, by the shield plates 35a and 35bc fixed to the rod 34 that moves in conjunction with the cover body 3, three transmissive photo sensors 32a, 32b, and 32c are set to a state indicated in the column “cover body opening angle=α1 (for example, 18 degrees)” of the operation table in FIG. 2A. The CPU receives the output information on three transmissive photo sensors 32a, 32b, and 32c when the cover body opening angle is equal to the angle α1 (for example, 18 degrees) and determines that the opening angle (the closing angle) of the cover body 3 is equal to the angle α1 (for example, 18 degrees). The CPU uses this as the trigger and turns on the light source 24.

The size of the original document in the sub-scanning direction 10 is detected by using the turn-on of the light source 24 as the trigger. Namely, the size of the original document in the sub-scanning direction 10 is detected based on the output signals of two size sensors 44. A method for detecting the size of the original document in the sub-scanning direction 10 is the same as the conventional one. Therefore, the detailed explanation will be omitted.

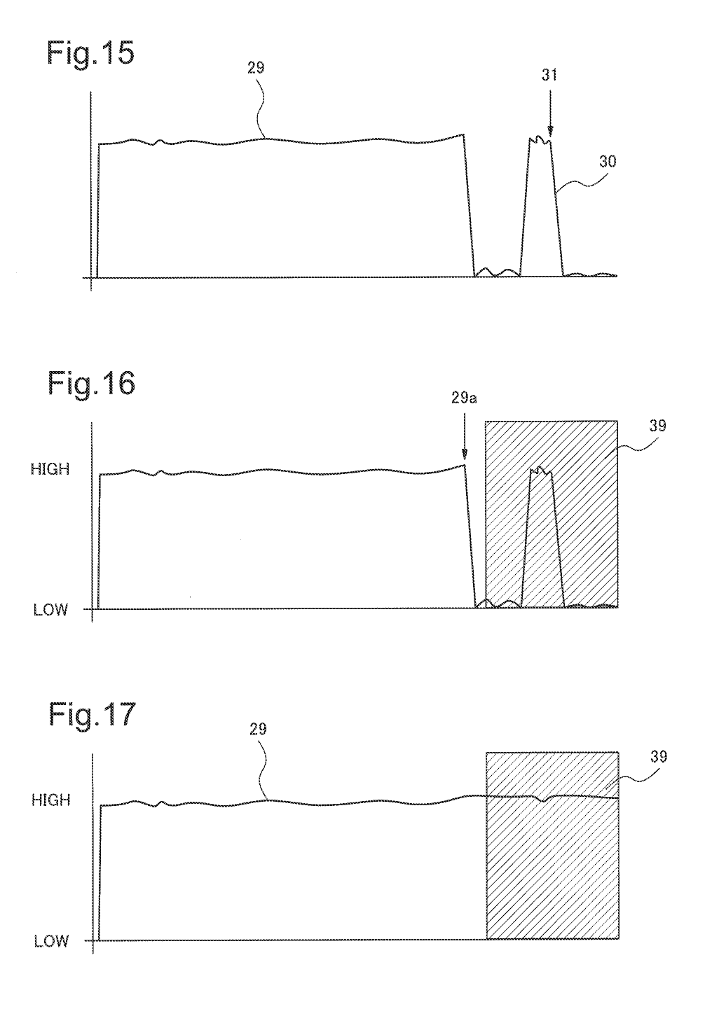

After this, the cover body 3 is further closed. Then, by the shield plates 35a and 35bc fixed to the rod 34 that moves in conjunction with the cover body 3, three transmissive photo sensors 32a, 32b, and 32c are set to a state indicated in the column “cover body opening angle=α2 (for example, 12 degrees)” of the operation table in FIG. 2A. The CPU receives the output information on three transmissive photo sensors 32a, 32b, and 32c when the cover body opening angle is equal to the angle α2 (for example, 12 degrees) and determines that the opening angle (the closing angle) of the cover body 3 is equal to the angle α2 (for example, 12 degrees). The CPU uses this as the trigger and determines the state of the CCD output waveform 29 of the light that is emitted by the light source 24 that is turned on when the opening angle (the closing angle) of the cover body 3 is equal to the angle α1 (for example, 18 degrees) and reflected by the original document 13. When the opening angle (the closing angle) of the cover body 3 is equal to the angle α2, the cover body 3 is not completely closed. Therefore, the external light 28 enters a reading area on the surface of the document reading table. Accordingly, the CCD 25 receives both the light reflected by the original document 13 and the external light 28 and outputs the combined information. As shown in FIG. 15, the combined information (CCD output waveform) includes a convex waveform 30 caused by the external light 28.

However, in the device according to the exemplary embodiment, the masking unit performs the electric masking process and the convex waveform 30 is masked as shown in FIG. 16. The CPU determines that the output waveform end portion 29a in the “High” state corresponds to the edge of the original document in the main scanning direction 11. By this, the size of the original document in the main scanning direction 11 can be known. However, as shown in FIG. 17, there is a case in which the output waveform end portion in the “High” state is included in the masking area. In such case, the CPU determines that the size of the original document in the main scanning direction 11 is maximum. Namely, by performing the electric masking process, the influence of the external light is prevented and the erroneous detection of the size of the original document caused by the external light does not occur.

After this, when the cover body 3 is further closed. Then, by the shield plates 35a and 35bc fixed to the rod 34 that moves in conjunction with the cover body 3, three transmissive photo sensors 32a, 32b, and 32c are set to a state indicated in the column “cover body opening angle=0 degree” of the operation table in FIG. 2A. At this time, the CPU determines that the cover body 3 is completely closed.

In the original document size detection device according to the present invention, two shield plates 35 (35a and 35bc) block (intercept) and pass (transmit:receive) the sensor light of three transmissive photo sensors 32 and the opening angles (the closing angles) α1 and α2 of the cover body is detected based on the combination of the outputs of three transmissive photo sensors 32 (32a, 32b, and 32c). As a result, a low price original document size detection device which can correctly determine the size of the original document placed on the document reading table even when the cover body is closed at high speed can be provided.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

What is claimed is:

1. An original document size detection device characterized by comprising
a document reading table,
a light source which irradiates an original document placed on the document reading table,
a cover body which covers the original document,
a light detection unit which detects a reflected light that a light from the light source is reflected by the original document,
an angle detection unit which detects an opening angle of the cover body and has a first photo sensor, a second photo sensor, a third photo sensor, and a shield plate, and
a determination unit which determines the size of the original document in a sub-scanning direction when the opening angle of the cover body is equal to an angle α1 and the size of the original document in a main scanning direction when the opening angle of the cover body is equal to an angle α2 (α1>α2) based on an output signal of the light detection unit and an output signal of the angle detection unit.

2. The original document size detection device according to claim 1 characterized in that the angle α1 is from 5 degrees to 25 degrees, the angle α2 is from 4 degrees to 24 degrees, and the angle of (α1−α2) is equal to or greater than 1 degree and equal to or smaller than 10 degrees.

3. The original document size detection device according to claim 1 characterized in that the light source is turned on when a closing angle of the cover body is equal to the angle α1, the reflected light is detected by the light detection unit, and the determination unit detects the size of the original document in the main scanning direction based on the output signal of the light detection unit.

4. The original document size detection device according to claim 1 characterized in that
the shield plate has a first shield plate and a second shield plate,
the first shield plate and the second shield plate have a notch and
the light of the first photo sensor passes through the notch of the first shield plate or is blocked by the first shield plate according to the operation of the first shield plate, and the light of the second photo sensor and/or the light of the third photo sensor passes through the notch of the second shield plate or is blocked by the second shield plate according to the operation of the second shield plate.

5. The original document size detection device according to claim 1 characterized in that
the first photo sensor and the second photo sensor are disposed on different lines in a vertical direction, respectively and
the second photo sensor and the third photo sensor are disposed at different positions on the same line in the vertical direction, respectively.

6. The original document size detection device according to claim 1 characterized in that
the original document size detection device uses a hinge to open and close the cover body around a hinge rotation shaft core which is disposed at one edge side of the document reading table in the sub-scanning direction and
the shield plate is disposed at the end of the hinge rotation shaft core side of the cover body.

7. The original document size detection device according to claim 1 characterized by comprising
a masking unit which masks a signal based on an incident external light when the opening angle of the cover body is equal to the angle α2 that is included in the output signal of the light detection unit.

8. An original document size detection device characterized by comprising
a document reading table,
a light source which irradiates an original document placed on the document reading table,
a cover body which covers the original document,
light detection means for detecting a reflected light that a light from the light source is reflected by the original document,
angle detection means for detecting an opening angle of the cover body and having a first photo sensor, a second photo sensor, a third photo sensor, and a shield plate, and
determination means for determining the size of the original document in a sub-scanning direction when the opening angle of the cover body is equal to an angle α1 and the size of the original document in a main scanning direction when the opening angle of the cover body is equal to an angle α2 (α1>α2) based on an output signal of the light detection means and an output signal of the angle detection means.
